(19) United States
(12) Patent Application Publication
(10) Pub. No.: US 2022/0332559 A1
(43) Pub. Date: Oct. 20, 2022

(54) HANDLING APPARATUSES IN A MACHINE PROCESSING CONTAINERS

(71) Applicant: SYNERLINK, PUISEUX PONTOISE (FR)

(72) Inventors: Dominique COSSAIS, SAINTE GENEVIÈVE DES BOIS (FR); Gaëtan DOITEAU, LE MANS (FR); Jean-Michel ROYER, PUISEUX PONTOISE (FR); Julie GUET, PUISEUX PONTOISE (FR)

(73) Assignee: SYNERLINK, PUISEUX PONTOISE (FR)

(21) Appl. No.: 17/721,507

(22) Filed: Apr. 15, 2022

(30) Foreign Application Priority Data
Apr. 16, 2021 (FR) 2103973

(51) Int. Cl. B67C 3/24; B65B 43/60

(52) U.S. Cl. CPC B67C 3/242; B65B 43/60

(57) ABSTRACT

A handling system in a machine for processing containers, including a plurality of support plates circulating in a closed circuit, each support plate including one or more housings, each housing being able to hold a container, for example of the bottle type, a working portion, in which the support plates circulate in a generally horizontal position, with a first member for moving the support plates, wherein each of the support plates has a turning plate configured to be pivoted through 180° between a first position and a second position, with, in the first position, the container having its neck oriented upwards and, in the second position, the container having its neck oriented downwards.

### FIELD

The present invention relates to handling apparatuses and systems in a machine processing containers for food products. These machines may also be referred to as production equipment or lines.

### BACKGROUND

These machines (or “equipment” or “lines”) are used to fill containers, for example pots or bottles, with one or more food products, for example a dairy product and/or food components, and to hermetically seal these containers, also optionally with marking, labelling, prior disinfection or some other operation.

These machines/equipment use supports, for example plates, to support the containers during the operations carried out in the machine.

These supports travel through a closed loop, returning empty after the processed container(s) have been unloaded from them.

This type of support plate is also used in machines or installations which process containers for non-food products, to which the present invention may be applied.

The users of this kind of installation are increasingly demanding flexibility since the end customers are asking for ever greater diversity in the format of the containers, i.e. their shape and their volume. The size of the runs for a given production campaign is also tending to decrease.

The need for an installation which can process pots and bottles is becoming increasingly important. Moreover, in the case of the bottle format, it is usual to carry out preparation (disinfection/decontamination) while the container is in an upside down position, i.e. with the opening directed downwards. Of course, the bottle then needs to be turned over to be subsequently filled.

It is in this context that the inventors have sought to provide a solution for the support plates in order for it to be possible to process the bottle format without any load transfer in the handling system.

### SUMMARY

To this end, a handling system in a machine for processing containers intended to hold a food product is therefore proposed, the handling system comprising:
a plurality of support plates (1) circulating in a closed circuit, each support plate comprising one or more housings, each housing (18) being able to hold a container (8), for example of the bottle type,
a first portion TC1, known as the working portion, in which the support plates circulate in a generally horizontal position in a first axial direction X1A, with a first member for moving the support plates along the first axial direction, characterized in that each of the support plates has a turning plate (6) configured to be pivoted through 180° between a first position and a second position, and, in the first position, the container has its neck oriented downwards and, in the second position, the container has its neck oriented upwards.

By virtue of these provisions, it is possible to process the case of containers in the bottle format on a production line which can also process the conventional case of pots. Specifically, the turning plate is pivoted within the first working portion, the support plate remaining in a horizontal position.

Note that this is made possible by a generally overhanging disposition of the guiding and driving of the support plates.

Bottles can be loaded upside down in order to decontaminate them, then the plate can be turned, and then the bottles can be filled the right way up, sealed and unloaded.

In various embodiments of the invention, it may be possible to also use one and/or another of the following provisions, taken individually or in combination.

According to one aspect, the support plate comprises a C-shaped reinforcement (also called strength member) with a body and two arms and the turning plate (6) is mounted so as to pivot about a turning axis X6 parallel to the longitudinal axis X of the machine, with respect to the two arms.

This amounts to simple and robust mechanical mounting. The support plate can continue to move forward parallel to itself in a generally horizontal plane while the turning plate is pivoted within the two arms of the support plate.

According to one aspect, a plurality of housings that open out at the edge face of the turning plate are provided, each housing being able to hold a bottle by its throat. This makes it possible to install containers having a throat with a mouth smaller than the body of the container, since it is not possible to insert it from above.

According to one aspect, the support plate comprises a main longitudinal edge (11), via which the plate is guided and set in motion, and on the opposite side, the support plate is at least partially overhanging so as to allow the turning plate to pivot with the bottles.

Note that the mechanical interface between the guiding and driving means of the handling system and the support plates, whether or not they are equipped with a turning plate, is an invariable feature of the system. The overhanging portion is necessary to allow the bottle bodies to pass through regardless of their size.

According to one aspect, the turning plate (6) has a first longitudinal edge (81) and a second longitudinal edge (82), each of the first and second longitudinal edges comprising openings for the insertion of the throats of bottles. There are thus a plurality of housings opening out at the edge face of the turning plate. This makes it possible to insert the bottles transversely by their throat, in an upside down position.

According to one aspect, on the turning plate, only one of the two longitudinal edges comprises openings for inserting the throats of bottles. Provided that the plates are pivoted back the opposite way after the bottles have been unloaded, it is thus possible to use a simplified turning plate with housings in the edge face on only one side. This also simplifies cleaning.

According to one aspect, it is provided that bottles are in an upside down position only on the side of the longitudinal edge that is situated between the axis of rotation X6 and the main longitudinal edge of the support plate.

According to one aspect, the turning plate is generally symmetric with respect to the turning axis X6. As such, the turning plate can be pivoted through only 180 degrees in the first portion during the working cycle.

According to one aspect, each support plate and/or each turning plate is preferably flat. This plate is then easy to manufacture from a cut blank. This is also an economical solution which minimizes re-machining operations.

According to one aspect, each support plate and/or each turning plate is made of stainless steel or of a food-compatible metal alloy. This brings about a lightweight and durable plate.

According to one aspect, an upper face of the support plate (including the turning plate) is defined, and nothing projects beyond the upper face apart, if necessary, from centring studs arranged at the periphery of the housings. Note that the upper faces of the plates in the working portion are flush with a working plane denoted PW.

According to one aspect, one or more stops are provided for stopping the rotation of the turning plate at the two end positions. By using the effect of gravity and the instability of the other positions, two stable mechanical positions are thus provided at the ends of the available angular travel.

According to one aspect, indexing, for example ball indexing, of the two angular end positions is provided. The axle bearings allowing the rotation of the turning plate can be equipped with a system for indexing the two end positions, for example an indentation and a ball pushed by a spring.

According to one aspect, turning means in the form of a rod or cam, outside the support plate, are provided. These turning means can be applied at a fixed station by a push rod or on the move depending on the forward movement via a cam effect.

According to one aspect, the plates have eight housings, or four or six or any other value. The invention works regardless of the number of housings provided in the plate.

According to one aspect, the plates have a longitudinal length PX of between 250 mm and 880 mm, preferably between 360 mm and 520 mm, and even more preferably between 400 mm and 480 mm.

According to one aspect, the plates have a thickness of between 3 mm and 10 mm. According to one particular example, a thickness of between 6 mm and 8 mm may be chosen.

The present invention also relates to a machine for processing pots or bottles for food products, comprising a handling system as described above.

Thus, the process modules can pass above and below without being impaired by the plate supports.

Further aspects, aims and advantages of the invention will become apparent from reading the following description of an embodiment of the invention, given by way of non-limiting example.

### BRIEF DESCRIPTION OF THE DRAWINGS

The invention will also be understood better from studying the appended drawings, in which:

FIG. 1 illustrates a profile view of a machine or equipment comprising a plate system according to the present invention,

FIG. 2 illustrates a perspective view of the machine in FIG. 1,

FIG. 3 illustrates a perspective view of a handling system according to one embodiment of the invention,

FIG. 4 illustrates a perspective view of the region of the first rotation station arranged at a first end of the system,

FIG. 5 illustrates a perspective view of the region of the second rotation station arranged at a second end of the system,

FIG. 6 illustrates a cross section through the handling system in the first portion, known as the working portion,

FIG. 7 is similar to FIG. 6, also illustrating the first moving member,

FIG. 8 illustrates a cross section through the handling system in the second portion, known as the return portion,

FIG. 9 illustrates a cross section through the handling system with the auxiliary support guide,

FIG. 10 shows a frontal view of the machine,

FIG. 11 illustrates a plate in a top view (A), a side view (B) and a frontal view (C),

FIG. 12 illustrates a frontal view of a plate variant,

FIG. 13 is similar to FIG. 9 and illustrates in more detail a cross section through the handling system according to one variant, at the longitudinal axis,

FIG. 14 is similar to FIG. 9 and illustrates in more detail a cross section through the handling system according to another variant, at the longitudinal axis,

FIGS. 15 and 16 illustrate the second return conveyor, in this case in a variant having a belt, and the drive thereof, the whole having the function of driving the vertically returning plates along the second portion,

FIG. 17 is similar to FIG. 1 and shows a variant of the general arrangement of the handling system with respect to the machine,

FIG. 18 is a view in transverse cross section of the support plate and its turning plate, in a position in which the bottles are upside down,

FIG. 19 is similar to FIG. 18 in a position in which the bottles are the right way up,

FIG. 20 is similar to FIGS. 18 and 19 and shows an intermediate position during the turning operation,

FIG. 21 illustrates a support plate with its turning plate, in a top view (A), a side view (B) and an end-on view (C), respectively,

FIG. 22 illustrates a perspective view of a support plate with its turning plate, a single bottle being shown, with the starting position shown in a phantom view and the end position being shown by way of solid lines,

FIG. 23 illustrates a perspective view of a support plate with its turning plate not being shown.

### DETAILED DESCRIPTION

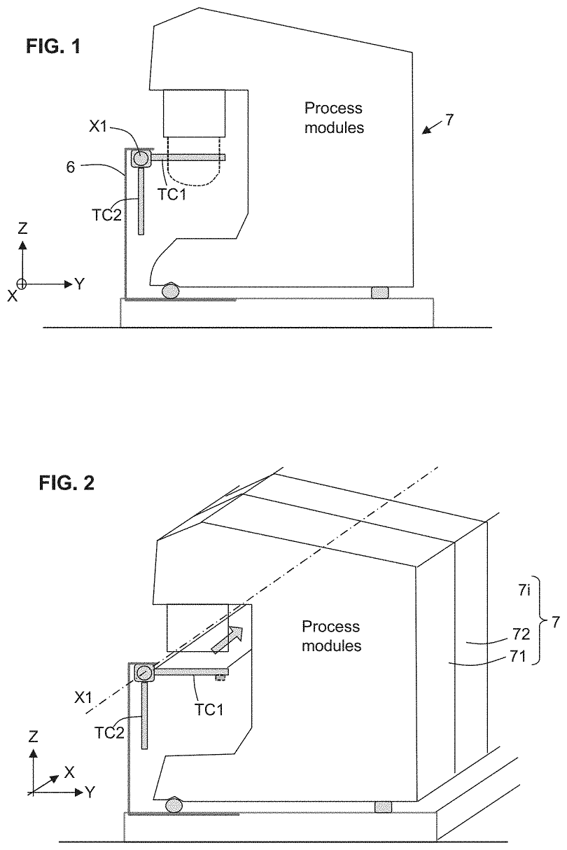

FIGS. 1 and 2 show a machine processing containers for food products. These may be milk products, syrups, beverages of all kinds, or even pasty or powdery products, without excluding ice creams and animal feed. The present invention applies in fact to any food product.

In particular the handling system employed in these machines is of interest here. However, note that the handling systems described below are applicable to any production line, even outside the food sector.

Returning to the food sector, these machines/equipment/lines are used to fill containers, for example pots or bottles, with one or more food products, for example a dairy product and/or food components, and to hermetically seal these containers. Marking, labelling or prior disinfection operations may also be provided. Any other operation is not ruled out, however. FIGS. 1 and 2 illustrate processing modules that are juxtaposed in the axial direction of the machine and respectively bear the references 71, 72, 7i. The different processing modules or process modules collectively bear the reference 7.

Supports, referred to as support plates, or even simply as plates, are used to support the containers during the operations carried out in the machine.

These supports, which generally bear the reference 1, travel through a looped, that is to say closed, circuit, in the machine, and they return empty after the processed container(s) has/have been unloaded from them.

According to a general arrangement, the handling system comprises a first portion TC1, known as the working portion. Moreover, the handling system comprises a second portion TC2, known as the rapid return portion.

Note here that the combination of the first portion TC1 and of the second portion TC2 jointly forms a closed circuit, that is to say a looped circuit in normal operation, with the rotation stations, described below, at the ends.

At one location, each support plate 1 is loaded with empty containers, and at another, downstream, location, the filled containers are removed from the support plate 1.

Each support plate 1 comprises one or more housings 18, each housing 18 being able to hold a container.

According to a first possibility, the container is held at the top, in which case an upper edge 58 of the container bears on an edge of the housing under the effect of gravity. The housing may be in the form of an orifice. According to this first possibility, the container is typically a pot 5 with a collar 58 wider than its body.

According to another possibility, the container can be received by lateral insertion, a throat of the container being accommodated in a housing having a mouth and a narrowing. After the throat of the container has passed through the narrowing, the container remains held in a hole with a size corresponding to the size of the throat. According to this other possibility, the container is typically a bottle 8 with a throat and a neck.

The present invention relates to the case of bottles with a mouth.

The number of housings may be four or eight. However, there may be any number of housings, from two to 16. The number of rows along the transverse axis Y may be one, two, or even four rows; in each of the rows, there may be from one to four housings.

According to a general arrangement, the handling system comprises a first end E1 and a second end E2.

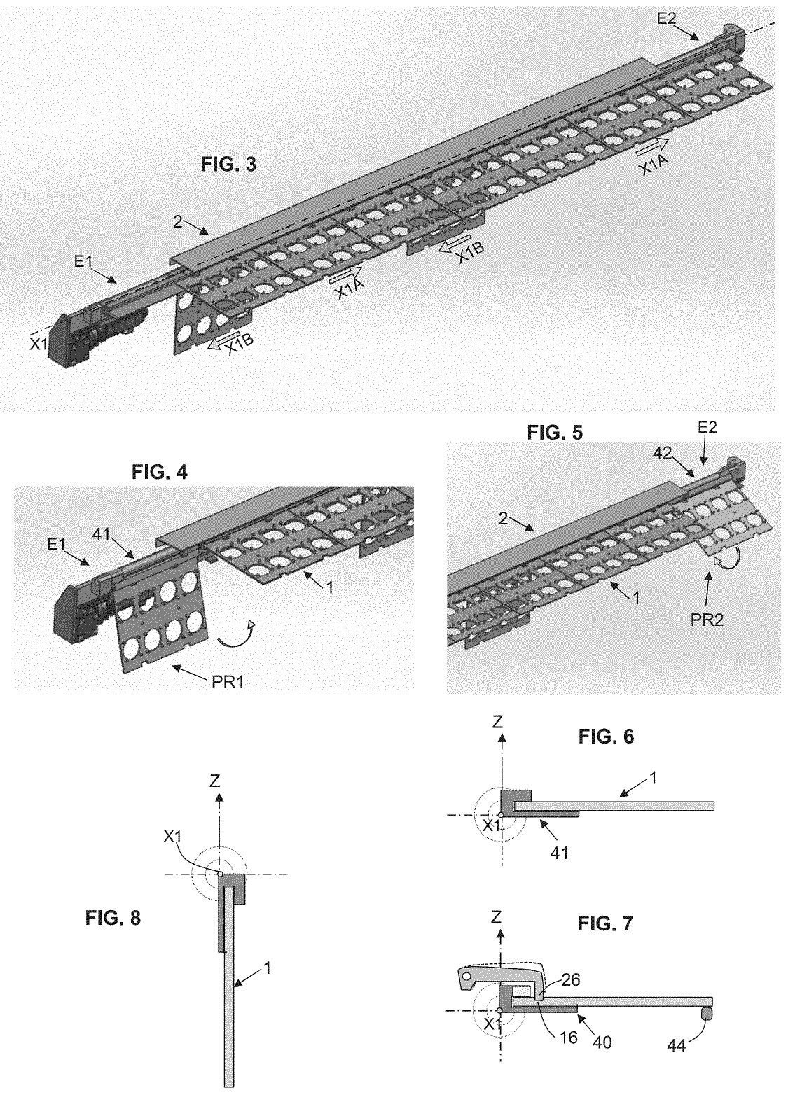

As illustrated in FIGS. 3 to 5, according to a general arrangement of the system, a first rotation station PR1 arranged at the first end E1 and configured to pivot the support plates into the horizontal position in order to engage them in the first portion TC1 is provided. Moreover, a second rotation station PR2 arranged at the second end E2 and configured to pivot the support plates into the return orientation in order to engage them in the second portion TC2 is provided.

The working longitudinal axis (i.e. of the machine) is denoted X; a reference longitudinal axis of the handling system denoted X1 is defined. The transverse axis of the machine is denoted Y and the local vertical axis is denoted Z.

The entire handling system is supported by a general support frame referenced 6 (depicted only generically in FIGS. 1, 2 and 17).

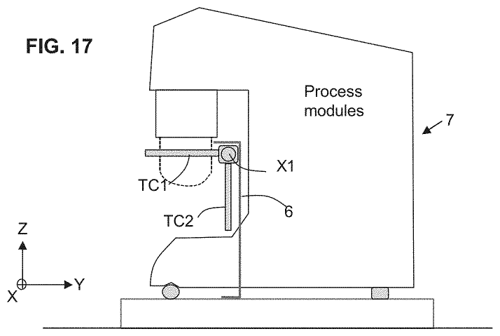

Note that two configurations are possible. In FIGS. 1 and 2, the axis X1 is situated on the outside of the machine, meaning that the plates 1 in the portion TC1 are located between the axis X1 and the process modules 7. In FIG. 17, the opposite is the case, and so the axis X1 is situated on the inside of the machine, meaning that the axis X1 is located between the plates 1 in the first portion TC1 and the process modules 7.

Support Plates and their Circulation

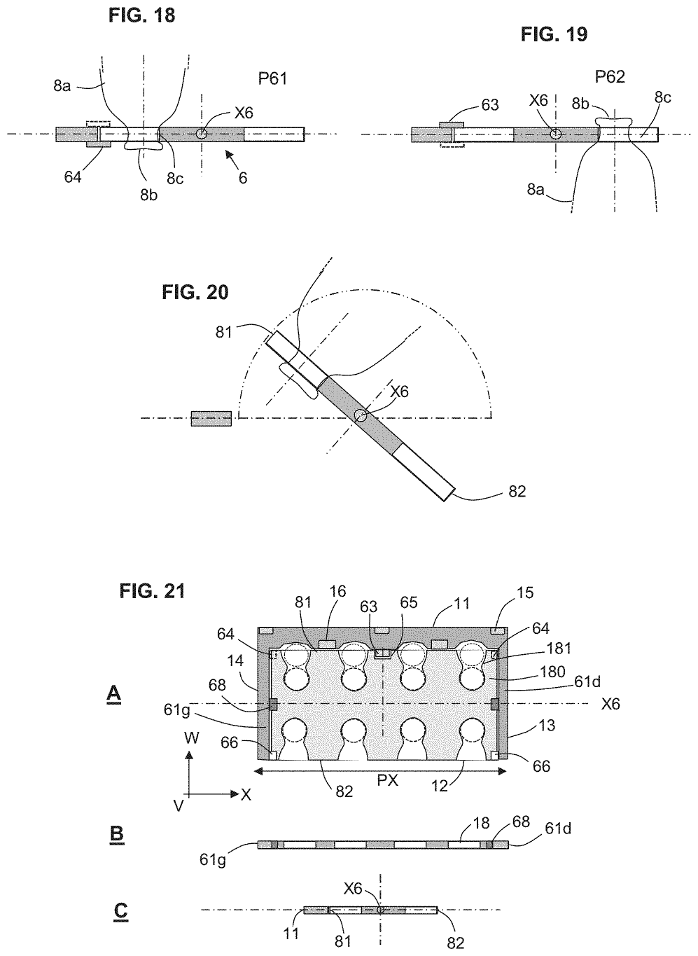

The support plates 1 may be of the simple type as described in relation to FIGS. 3 to 16, but support plates 1 may be of the articulated type with a turning plate as will be described below in relation to FIGS. 18 to 23.

As can be seen in FIGS. 3 to 9 and 11A, 11B, 11C and 12, each support plate 1 extends generally in a reference plane PR with a rectangular overall shape. Each support plate comprises two short sides, referenced 13 and 14, respectively, parallel to the Y direction of the machine. Each support plate has two long sides parallel to the longitudinal direction X of the machine, namely a first long side 11 forming a guiding and manoeuvring edge, and another long side 12 forming a free edge. The longitudinal length denoted PX is in this case between 400 mm and 480 mm. However, more generally, the length PX may be between 250 mm and 880 mm, or between 360 mm and 520 mm. The width of the plate, denoted LW, is in this case between 250 mm and 350 mm. However, more generally, the width LW may be between 200 mm and 500 mm.

Note that a small longitudinal clearance may be provided between the plates.

Each support plate is made in one piece. Each support plate is flat. The thickness of a plate EPP may typically be between 3 and 10 mm. Typically, the starting point is a blank of constant thickness and notches and grooves are made therein, which will be discussed below. According to one example, the thickness EPP may be 8 mm. According to another example, the thickness EPP may be between 6 mm and 8 mm.

Each support plate 1 comprises an upper face 1A and a lower face 1B.

Each support plate 1 can be made of stainless steel or of a food-compatible metal alloy. However, a material of the food-compatible hard plastic type, such as polypropylene or polycarbonate may also be suitable.

In the first portion TC1, the support plates circulate in a horizontal position in a first axial direction X1A. In the various illustrations, the plates are adjacent to one another in the first portion. However, they are not precluded from being slightly spaced apart from one another.

In the return portion TC2, the support plates travel forward in a second axial direction X1B opposite to the first axial direction. In this second portion TC2, the support plates circulate in a position/stance or orientation which is different from the horizontal position. The term “return orientation” is used for this position. Said return orientation is vertical in the example depicted. In a variant that is not shown, the return orientation may be angularly less than 30° away from the vertical, that is to say not far away from the vertical position.

The first long side 11 forms a guiding and manoeuvring edge. The guiding and driving functions are located in the vicinity of this long side. The edge corresponding to this long side is received in one or more groove(s) for guiding and receiving guides and rotary bases, as will be described below.

The opposite edge 12 is only guided but not driven. The drive is thus relatively simple and is located in the vicinity of the longitudinal axis X1 of the handling system.

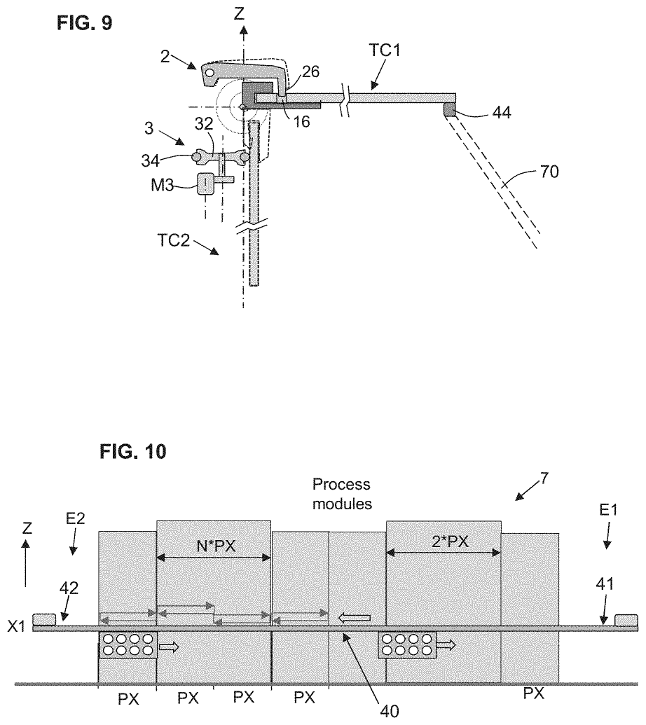

According to another characteristic, the opposite long edge 12 may be supported by an auxiliary guide 44. This auxiliary guide may be continuous or discontinuous; as illustrated in FIG. 9, this auxiliary guide 44 may be carried by an arm 70 secured to one of the abovementioned process modules 7i. This auxiliary guide 44 is preferably removable.

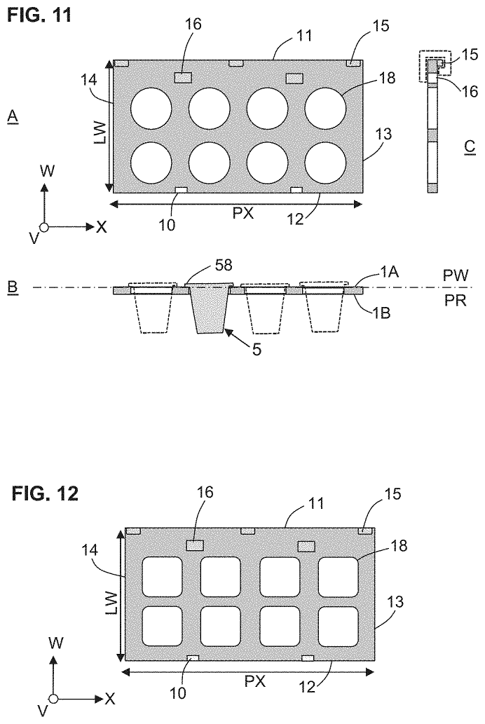

With reference to FIGS. 11 and 12, it can be seen that the housings provided in the support plate can be round or square depending on the shape of the pots to be processed.

Each support plate comprises at least one notch 16 for receiving a finger of the first moving member. Note that the notch(es) 16 preferably pass(es) through the thickness of the plate. This is easy to clean and prevents contaminants from getting trapped in a blind hole.

In the example illustrated, each support plate comprises two notches.

Moreover, according to one option, a protrusion 15 forming a projection out of the plane is provided, this serving to keep the plate in particular in its vertical orientation.

According to one configuration, rather than a protrusion, a longitudinal groove referenced 19 is used to hold the plate, a longitudinal rib 28, 29 provided in the plate guiding means being accommodated in said groove.

In a variant that is not shown, the position of the notches 16 for the forward travel of the plates and the position of the longitudinal groove 19 for holding and guiding may be coincident.

Moreover, auxiliary notches referenced 10 may be provided, which may be used for the purposes of indexing at the processing stations.

Note also that the plate may have a square rather than rectangular overall shape.

Moreover, note that the short sides are not necessarily straight and may comprise a convex or concave step.

Moving Members

Provided in the first portion is a first member 2 for moving the support plates along the first axial direction X1A. In an illustrated configuration, the first member is of the stepping type. However, note that any other moving mechanism can be envisaged in the scope of the present invention.

The first moving member 2 comprises, in the example illustrated, a transfer bar 21 which extends generally along the axial direction and is mounted so as to pivot about the axis X1.

The transfer bar 21 of the first moving member 2 comprises a finger 26 at a distance from the axis X1 and configured to be received in a notch 16 in the plate, the finger and the transfer bar being unladen when the finger 26 is not engaged.

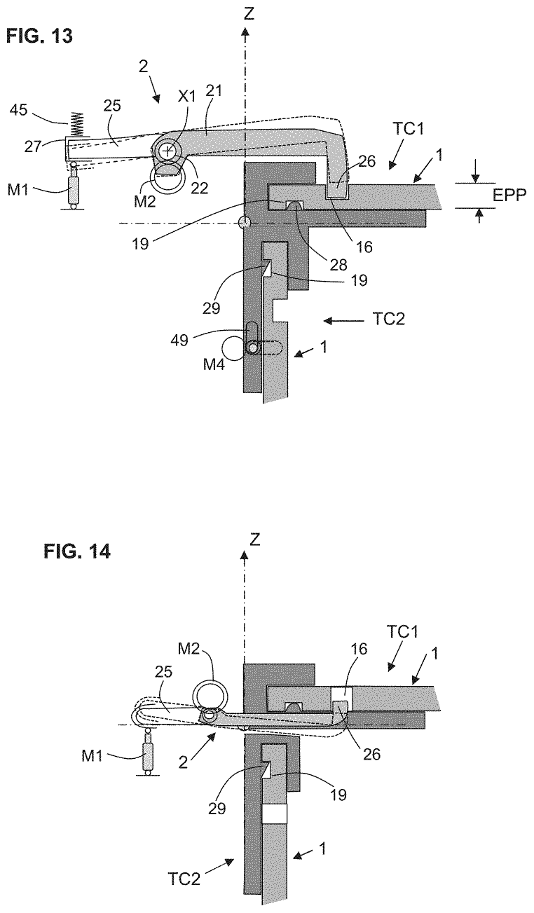

As illustrated in FIGS. 13 and 14, the transfer bar 21 of the first moving member 2 operates with two degrees of freedom, namely a rotation about X1 and forward movement along the axial direction. The rotation allows the engagement and disengagement of the finger 26 in and from a notch 16.

The axial movement in translation makes it possible to move one or more plates forward by a predetermined distance in the first portion. In the example illustrated in FIG. 10, the predetermined distance coincides with the axial length of the plate, namely the pitch PX. According to other possibilities, for example with two notches per plate, the forward travel distance on each movement of the transfer bar may be PX/2. According to other possibilities, for example with four notches per plate, the forward travel distance on each movement of the transfer bar may be PX/4.

The axial movement in translation is realized by a screw-nut or rack mechanism, and it is generally possible to use an axial translation mechanism known per se. An axle shaft denoted 22, which may be fixed or secured to the transfer bar itself, is provided. The device also comprises a motor denoted M2, or a geared motor, which is placed in the vicinity of the axle shaft. An output pinion engages with a rack or a helical toothset in order to move the transfer bar 21 along the longitudinal direction X1, with rotation of the axle shaft 22 or not depending on the possible configurations.

Where the engaging and disengaging movement of the finger is concerned, the transfer bar is equipped with a rear lever referenced 25 securely connected to the body of the transfer bar; the rear lever 25 is received in a sliding connection 27. The rear lever 25 can thus slide along X1 in the longitudinal slide 27. As in the case illustrated in FIG. 13, a single-acting control cylinder denoted M1 and a return spring 45 are provided. The effect of the return spring is to tilt the transfer bar about the axis X1 to the disengaged position of the control finger 26, whereas, by contrast, the actuation of the cylinder M1 has the effect of tilting the transfer bar in the opposite direction and engaging the control finger in the notch 16.

FIG. 14 illustrates the case of a double acting cylinder; in this case, the cylinder is commanded in one direction to disengage the control finger, and commanded in the opposite direction to engage the control finger 26 so as to move the plates forward.

Thus, the first moving member 2 can be referred to as a “transfer shuttle”. Any other solution for causing at least one plate to move forward by a predetermined distance can also be envisaged.

As regards the number of fingers 26, as many fingers can be provided as there are spaces for support plates in the first working portion; under these conditions, the transfer shuttle simultaneously engages all the plates situated in the working portion TC1. Thus, the transfer bar 21 and the axle shaft 22 travel along more or less the entire length of the handling system, possibly except for the ends. Thus, the plates do not push one another and are not necessarily adjacent. This also makes it possible to operate the tested machine with only a few plates.

In another variant, the transfer shuttle engages only the first plate situated at the start of the first portion and the plates push one another as far as the end of the first portion. The axle shaft and the transfer bar are thus much shorter, that is to say the order of magnitude corresponding to the length of a plate PX or slightly more.

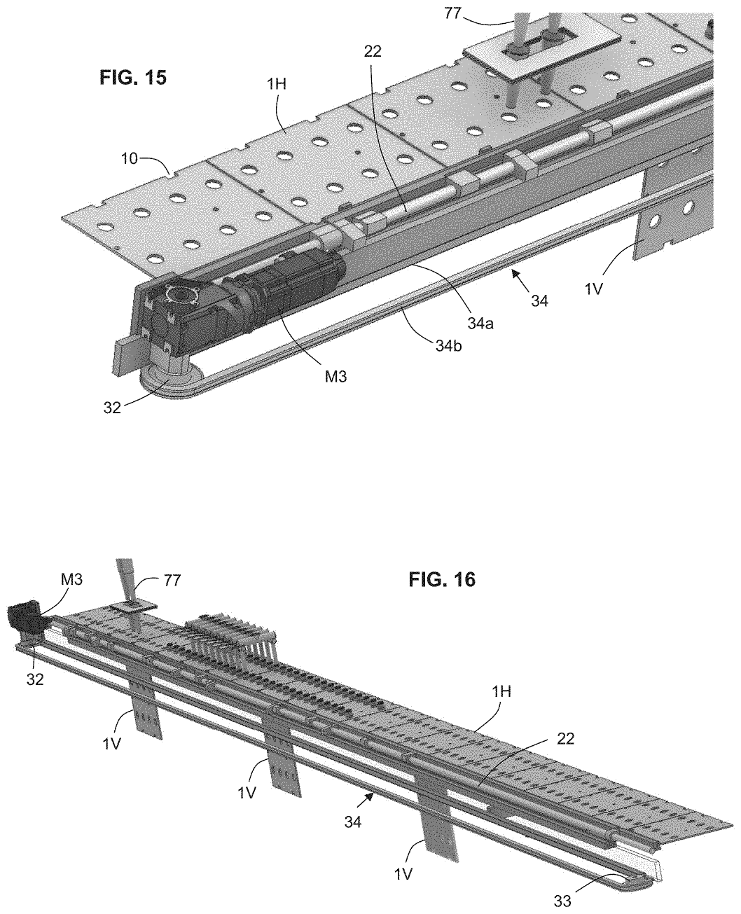

Alternatively, the transfer shuttle may work underneath, as illustrated in FIGS. 14 and 15, this case being illustrated below. When the transfer bar 21 is situated beneath the upper face 1A of the plates in the working portion, the region situated above the working plane referenced PW is free of any element that may represent an impairment or risk of contamination.

When the cylinder M1 pushes upward, the control bar tilts about X1 and the control finger 26 is disengaged from the notch 16. By contrast, when M1 pushes downward, the control bar tilts in the opposite direction about X1 and the control finger 26 is engaged in the notch 16.

The handling system comprises a second moving member 3 configured to move the support plates in the second axial direction X1B in the second portion TC2. The second moving member may be of the continuous or discontinuous type.

As can be seen in FIGS. 9, 15 and 16, the second moving member comprises an endless belt referenced 34. This belt is guided and driven by two belt pulleys, one of which is a driving pulley 32 driven by a motor M3 and one of which is a follower pulley 33 at the other end of the belt. The belt rubs against the lower face 1B of the plates, in the return orientation position, namely in the vertical position, in order to drive them from the second end E2 to the first end E1.

The belt may have a set of teeth on the inside to be driven by the motor-driven pulley and a set of teeth on the outside for the plates to be driven by the belt.

Rather than the belt, the second moving member may be formed by a chain of articulated links mounted in a loop on two sprockets at the ends. A first sprocket is a driving sprocket and the other is mounted on a support returned elastically by a spring in order to tend to maintain sufficient tension in the chain permanently. Shoes fixed on the outside of certain links of the looped chain may be provided in order to bear on the plates in their vertical position, which are in the return portion TC2.

More specifically, a working strand 34a is arranged in contact with the plates which are located in the second portion, while a return strand 34b is at a distance from the plates and serves for the unladen state. The rate of forward movement of the working strand of the belt is relatively fast. In practice, it is at least equal to the rate of forward movement of the transfer bar in the opposite direction. For example, the rate of forward movement of the belt 34 may be at least equal to 500 mm per second.

The drive of the plates in the second portion could be different from the one illustrated, for example a system involving a pulse, return by gravity, or any other solution made possible by the fact that there is no working operation on the plates in this return portion.

As illustrated in FIGS. 6 to 8, the first rotation station PR1 comprises a first rotary base 41 on the side of the first end E1. The first rotary base pivots the support plates into the horizontal position in order to engage them in the first portion TC1. The first rotary base may be in the form of an element mounted so as to rotate about an axis coincident with X1 or close to the latter, this element being driven into angular position by a geared motor with two end-of-travel sensors or a stepping motor with an end-of-travel sensor.

The first rotary base 41 is therefore movable between a first position suitable for receiving a support plate arriving in the second portion in a return orientation and a second position suitable for placing a support plate in a horizontal position at the inlet of the first portion.

A retractable stop 49 may be provided, which makes the inlet of a returning vertical plate into the rotary base 41 dependent on a vertical receiving position of this rotary base. The retractable stop 49 may be controlled selectively by a small actuator M4. In a variant, the retractable stop may be a form integrated into the flank of the rotary base 41, without requiring a specific control other than the rotation of the rotary base 41.

On the side of the second end E2, the second rotation station PR2 comprises a second rotary base 42. The second rotary base pivots the support plates into the return orientation in order to engage them in the second portion TC2.

The second rotary base may be in the form of an element mounted so as to rotate about an axis coincident with X1 or close to the latter, this element being driven into angular position by a geared motor with two end-of-travel sensors or a stepping motor with an end-of-travel sensor. If the path is free, the second rotary base pivots the plate into a vertical position and inserts it immediately into the second return portion TC2.

Each of the rotary bases comprises a groove for receiving the longitudinal edge, i.e. the long side 11 forming a guiding and manoeuvring edge.

Both the first rotary base and the second rotary base comprise a plate holding means. When the plate contains a projection out of the plane 15, the rotary bases comprise a housing forming a slide for receiving this projection out of the plane (cf. FIG. 11).

In a variant, the rotary bases comprise a protruding rib 29 which supports the interior of the groove 19 formed in the plates.

Moreover, a fixed main guiding support 40, disposed continuously along the first axial direction X1A, is provided between the first and second rotary bases 41, 42. The support is thus continuous for the plates from the first end E1 to the second end E2.

The main guiding support comprises a rib 28 which allows the longitudinal guiding of the plates, the rib 28 being received in the groove 19.

As illustrated in FIG. 13, the main guiding support is in the form of a profiled element having a generally constant section along X1. This profiled element makes it possible to guide plates in a horizontal position which pass through the first portion TC1, and also to guide plates in a vertical position in the second portion TC2, in which they return.

This type of system with support plates can also be used in machines or installations which process containers for non-food products, to which the present invention may be applied.

Operation

In the first working portion, the plates are moved sequentially from one station to another by the first moving member 2 described above. The plates are in a horizontal position referenced 1H in FIGS. 15 and 16. Depending on the configuration of the machine, various operations are carried out at a fixed station, in the period of time between the outward movements of the transfer bar. According to a very simplified example, illustrated in FIG. 15, metering nozzles referenced 77 are provided, located at the location of one of the positions of the plate.

At the end of the working portion TC1, the second rotary base 42 rotates each support plate 1 about the reference longitudinal axis X1 through an angle θ (90° in a typical case). Thereafter, each plate travels along the return portion, substantially maintaining this orientation. The plates are in a vertical position referenced 1V in FIGS. 15 and 16. The plates are moved along the second portion TC2 by the second moving member 3 described above.

Thereafter, the first rotary base 41 rotates the support plate with a rotation in the opposite direction about the longitudinal axis X1 through an angle −θ, that is to say opposite to the angle applied by the second rotary base.

In relation to the full operation in a loop, note that the first portion TC1 is entirely occupied by the plates, while the second portion TC2 comprises only a few plates, as can be seen in FIG. 16.

Thus, the number of plates in the first portion may be between about ten and about 30 depending on the configuration of the machine. By contrast, there are only one to four plates in the return portion TC2. Advantageously, the number of plates required for the handling system and the process of the installation is minimized.

Support Plates with a Turning Plate

Note that the system of the support plates with a turning plate 6 which will now be described can be used in the context of conventional material handling devices (i.e. a handling system), with a return of the plates in a flat state or after complete turning (180°).

However, where the system of support plates 1 with a turning plate as described in relation to FIGS. 18 to 23 is concerned, everything that is not described in particular should be considered as being identical or similar to the description given for the one-piece plates in relation to FIGS. 3 to 16.

In this case, the support plate comprises a C-shaped reinforcement/strength member with a body 60 and two arms 61g, 61d, as can be seen in particular in FIG. 21. The body 60 forms the main interface with the first member 2 for moving the support plates along the first axial direction in the working portion TC1. The body 60 extends along the longitudinal direction along the plate length PX. The body 60 corresponds to the first long side 11 forming a guiding and manoeuvring edge for the plate in general.

The two short sides referenced 13 and 14, respectively, which are parallel to the Y direction of the machine, correspond respectively to the right-hand arm 61d and to the left-hand arm 61g of the C-shaped reinforcement.

The body 60 comprises at least one notch 16 for receiving a finger of the first moving member 2. For guiding, it is provided with protrusions 15 that form a projection out of the plane and/or a longitudinal groove referenced 19, similarly to the description already given above.

The main difference resides in the presence of a turning plate 6. The turning plate 6 is a plate, preferably with the same thickness as the C-shaped reinforcement. However, the plate body and the turning plate could have different thicknesses.

The turning plate 6 has two longitudinal edges denoted 81, 82. More specifically, a first longitudinal edge 81 and a second longitudinal edge 82 are provided.

The first longitudinal edge 81 comprises openings 180 allowing the insertion of the throats of bottles. Each of the openings 180 (in this case 4) has a mouth slightly wider than the throat 8c, then a narrowing 181 which has a size slightly smaller than that of the throat 8c and a blind end for receiving the throat once the bottle has been inserted. The collar 8b at the mouth of the bottle rests on the housing.

In other words, there are thus a plurality of housings opening out at the edge face of the turning plate.

Optionally, on the second longitudinal edge 82, openings 180 allowing the insertion of the throats of bottles may also be provided. In this case, the turning plate is generally symmetric with respect to the turning axis.

However, in a variant, the housings are provided only on one of the edge faces of the turning plate.

The turning plate 6 is mounted on the C-shaped reinforcement by a pivoting articulation of axis X6. More specifically, the turning plate 6 is mounted so as to pivot with respect to the two arms 61g, 61d about the turning axis X6 parallel to the longitudinal axis X of the machine.

The turning plate 6 is therefore movable between several positions by way of this rotation.

More specifically, the turning plate 6 can be pivoted through 180 degrees between a first position denoted P61 and a second position denoted P62.

In the first position P61, the container/bottle has its neck oriented downwards. It is in this position that the empty bottle(s) is/are inserted by way of their throat into the turning plate. It is in this position that the empty bottle(s) is/are disinfected and/or decontaminated by a jet of decontaminating fluid coming from below.

Note that enough space is provided between the turning plate and the plate body 60 to lower the necks of bottles before inserting them into the housings. This is shown by way of dotted lines in FIG. 21A.

In the second position P62, the container/bottle has its neck oriented upwards. It is in this position that the bottle(s) is/are filled and capped and then unloaded.

According to one possibility, shown in the figures, two angular end-of-travel stops are provided, thereby limiting the possible rotation of the turning plate to half a turn. The first stop 63 is arranged half-way along the longitudinal length, and from the body, it protrudes towards the axis X6 and extends just above the upper plane of the plate, as illustrated in FIG. 19. The first stop 63 fixes the second position P62, rendered stable by gravity and the presence of the bottles.

The other stops 64 are arranged at the corners, at the angle of the body and each arm. The other stops 64 extend just below the lower plane of the plate, as illustrated in FIG. 18. The other stops 64 fix the first position P61, rendered stable by gravity and the presence of the bottles.

In other words, the stops (63, 64) are provided to stop the rotation of the turning plate at the two end positions P61 and P62.

As can be seen in FIG. 21, to allow the complete movement through 180 degrees, a recess 65 slightly wider than the stop 63 is provided, thereby allowing the rotation as far as the first position P61. Similarly, corner recesses 66 corresponding to the corner stops 64 are provided, so that there is no obstruction for the complete movement as far as the second position P62.

According to another possibility, the end positions P61, P62 are indexed by the axis of rotation and the system does not have stops.

According to another possibility, indexing and the above-described stops can be combined.

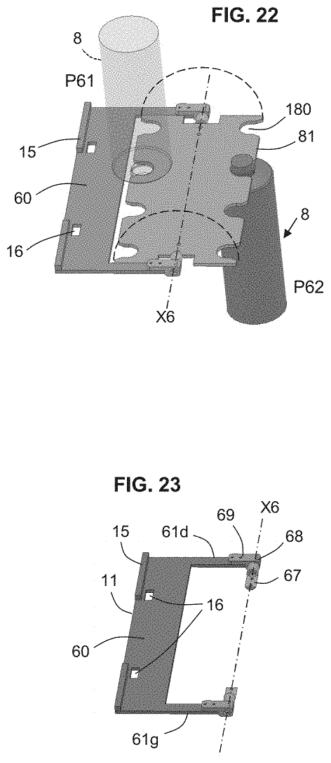

On the opposite side to the guiding edge 11, the plate in general is located at least partially in an overhanging manner so as to allow the turning plate to pivot with the bottles. Specifically, the bottle body 8a describes an arc of consistent radius (cf. FIGS. 20 and 22).

Provided on the two arms are bearings 68 that provide support for the rotation, the turning plate swivelling on these bearings, by virtue of hubs 67 on which the turning plates are fixed. Each bearing 68 is part of an end fitting 69 fixed to the arm, as illustrated in FIG. 23.

To make the turning plate turn, turning means in the form of a rod or cam, outside the support plate, are provided, which push the turning plate. The push kinematics may be straight or circular following the dotted lines shown in FIG. 22.

According to one example, these turning means can be applied at a fixed station by a push rod.

According to another solution, use may be made of a continuous means, which acts on the move depending on the forward movement by a cam effect. Advantageously, at one location on the machine, there is provided a first turning means for passing each turning plate, after it has been loaded with bottles, from the first position P61 to the second position P62.

At a downstream location, after unloading, or very far upstream before loading with empty bottles, there may be provided a second turning means for turning each empty turning plate from the second position P62 to the first position P61.

Note that the length of the arms 61g, 61d may be shorter than the overall width LW of the plates.

1. A handling system in a machine for processing containers intended to hold a food product, the handling system comprising:
a plurality of support plates circulating in a closed circuit, each support plate comprising one or more housings, each housing being able to hold a container, for example of the bottle type,
a first portion, known as the working portion, in which the support plates circulate in a generally horizontal position in a first axial direction, with a first member for moving the support plates along the first axial direction,
wherein each of the support plates has a turning plate configured to be pivoted through 180° between a first position and a second position,
and, in the first position, the container has its neck oriented downwards and, in the second position, the container has its neck oriented upwards.

2. The system according to claim 1, wherein the support plate comprises a C-shaped reinforcement with a body and two arms and the turning plate is mounted so as to pivot about a turning axis parallel to the longitudinal axis of the machine, with respect to the two arms.

3. The system according to claim 1, wherein a plurality of housings that open out at the edge face of the turning plate are provided, each housing being able to hold a bottle by its throat.

4. The system according to claim 1, wherein the support plate comprises a main longitudinal edge, via which the plate is guided and set in motion, and the opposite longitudinal edge is at least partially overhanging so as to allow the turning plate to pivot with the bottles.

5. The system according to claim 1, wherein the turning plate has a first longitudinal edge and a second longitudinal edge, each of the first and second longitudinal edges comprising openings for the insertion of the throats of bottles.

6. The system according to claim 5, wherein it is provided that bottles are in an upside down position only on the side of one of the longitudinal edges that is situated between the axis of rotation and the main longitudinal edge of the support plate.

7. The system according to claim 1, wherein the turning plate is generally symmetric with respect to the turning axis.

8. The system according to claim 1, wherein one or more stops are provided for stopping the rotation of the turning plate at the two end positions.

9. The system according to claim 1, wherein ball indexing is provided at the two angular end positions.

10. The system according to claim 1, wherein turning means in the form of a rod or cam, outside the support plate, are provided.
